(19) United States
(12) Patent Application Publication
(10) Pub. No.: US 2004/0181792 A1
(43) Pub. Date: Sep. 16, 2004

(54) Method to control, manage and monitor batched command files

(76) Inventor: Gaston M. Barajas, Austin, TX (US)

Correspondence Address: HAMILTON & TERRILE, LLP, P.O. BOX 203518, AUSTIN, TX, 78720, US

(21) Appl. No.: 10/386,851

(22) Filed: Mar. 12, 2003

(51) Int. Cl. G06F 9/46

(52) U.S. Cl. 718/101

(57) ABSTRACT

A method for managing a batched command file. The method includes providing a batched command file to a wrapper application, providing an initialization file to the wrapper application and executing the batched command file with the wrapper application using the rules base provided by the initialization file. The initialization file includes a rules base for commands within the batched command file.

### BACKGROUND OF THE INVENTION

1. Field of the Invention

The present invention relates to the field of information handling systems and more particularly to batched command files used with information handling systems.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

It is known to batch commands within batch files that are executed on an information handling system. Known files of batched commands, i.e., batch files, call command line executables and system commands in a sequential form (i.e., one after another). Each command in a batch file might fail or expect input from the user. Also, an expected output from a command call within a batch file may be another file; if this other file provides no return code, then the execution of the batch file may hang. Other than directing output to a display or a file, there is no standard method to handle errors or expected user input/output when executing a batch file.

Additionally, when the batch file is executing in a single threaded environment, executing a separate process to monitor the success or failure of each individual steps within the batch file is often not possible. An example of a batch file is set forth as FIG. 1A.

A known method of adding error handling to this batch file checks a return code for each step of the batch file and acts accordingly. An example of a batch file which adds this error handling capability to the example batch file is set forth as FIG. 1B. Such an error handling process does not allow for specific processing/monitoring of command completion. In this example in particular there is also no indication of where in the process the error occurred. This method of error handling may become quite cumbersome for a developer of batch files.

### SUMMARY OF THE INVENTION

In one embodiment, the invention relates to a method for managing a batched command file. The method includes providing a batched command file to a wrapper application, providing an initialization file to the wrapper application and executing the batched command file with the wrapper application using the rules base provided by the initialization file. The initialization file includes a rules base for commands within the batched command file.

In another embodiment, the invention relates to a system for managing a batched command file. The system includes a wrapper application, a batched command file, and an initialization file. The batched command file is provided to the wrapper application. The initialization file is provided to the wrapper application. The initialization file includes a rules base for commands within the batched command file. The wrapper application executes the batched command file using the rules base provided by the initialization file.

In another embodiment, the invention relates to an information handling system. The information handling system executes a batched command file and includes a processor, a memory coupled to the processor, a wrapper application stored on the memory, a batched command file stored on the memory, an initialization file stored on the memory. The batched command file is provided to the wrapper application when the wrapper application executes. The initialization file is provided to the wrapper application when the wrapper application executes. The initialization file includes a rules base for commands within the batched command file. The wrapper application executes the batched command file using the rules base provided by the initialization file.

In another embodiment, the invention relates to an apparatus for managing a batched command file. The apparatus includes a wrapper application, means for providing a batched command file to the wrapper application, means for providing an initialization file to the wrapper application, the initialization file including rules base for commands within the batched command file, and means for executing the batched command file with the wrapper application using the rules base provided by the initialization file.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1A, labeled prior art, shows an example of a batch file.

FIG. 1B, labeled prior art, shows an example of a batch file incorporating error checking.

FIG. 2 shows a block diagram of an information handling system incorporating a batched command file.

FIG. 3 shows a block diagram of a method for controlling, managing and monitoring batched command files.

FIG. 4 shows an example of a .INI file.

FIG. 5 shows an example of a wrapper application processing a batched command file call.

FIG. 6 shows an example of a possible error event that may be generated during the execution of a batched command file.

### DETAILED DESCRIPTION

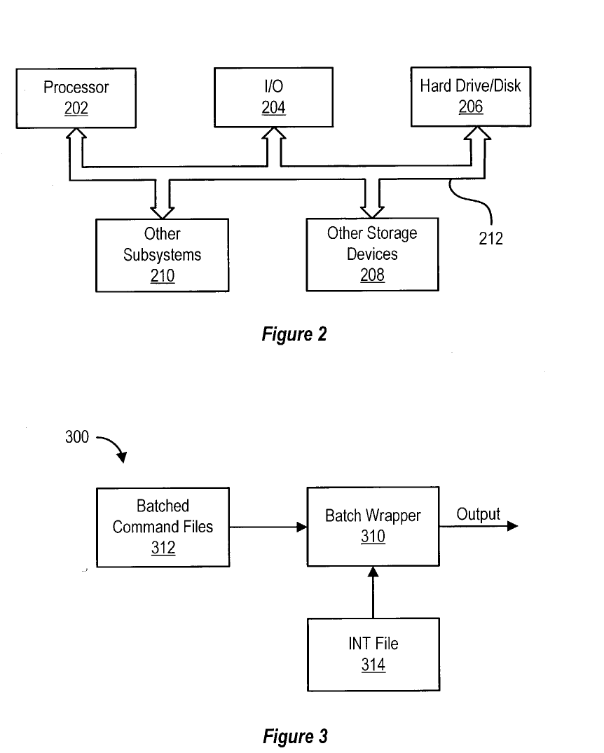

Referring briefly to FIG. 2, a system block diagram of an information handling system 200 is shown. The information handling system 200 includes a processor 202, input/output (I/O) devices 204, such as a display, a keyboard, a mouse, and associated controllers, a hard disk drive 206, and other storage devices 208, such as a floppy disk and drive and other memory devices, and various other subsystems 210, all interconnected via one or more buses 212. Batched command files are stored on a non-volatile memory such as the hard drive 206. The batched command files are then executed by the processor 202 when the command is called by the processor 202. Often a batched command file is called during the initial start up of the information handling system.

For purposes of this invention, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

Referring to FIG. 3, a method for controlling, managing and monitoring batched command files 300 is shown. The method 300 includes a wrapper application 310 which monitors and reacts to command calls and return codes as well as any expected output from the command calls.

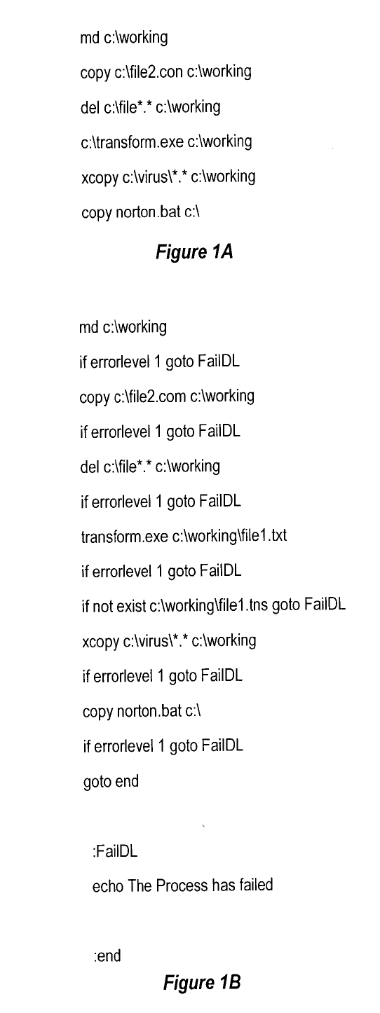

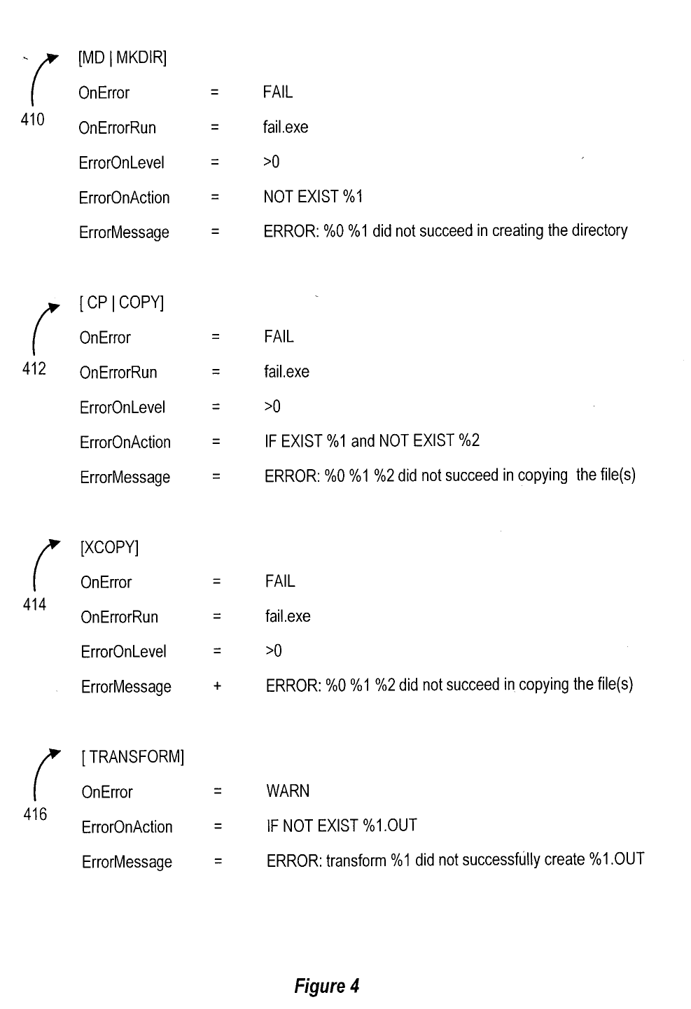

The wrapper would take an original batch file such as that set forth in FIG. 1A as batched command file 212. In addition, the wrapper application 310 reads a rules based INI file 314 to determine the consequences of each call. Examples of rules based INI files are set forth in FIG. 4.

The wrapper application 310 receives as input a batched command file 312 and a wrapper initialization (INI) file 314. The wrapper INI file 314 provides information which is used when launching the wrapper application 310. More specifically, the wrapper INI file 314 provides a rules base to determine what output/return to expect during the execution of the batched command file 312. The rules base provides “if this, do that” rules to perform actions. The rules based INI file provides flexibility by enabling tasks and data to be easily changed by replacing one or more of the rules. The wrapper INI file 314 also provides a rules base to the wrapper application 310 on how to react to particular outputs, returns or the absence of the expected output/return (i.e. error) during the execution of the batched command file 312.

Additionally, because the batched command file 300 is processed by the wrapper application 310, functions that are normally not available in batch files may be supported by the wrapper application 310. Examples of such functions include a logging to database function and a formatted output function.

Referring to FIG. 4, an example of a wrapper INI file 314 that corresponds to the batched command file set forth in FIG. 1A is shown. More specifically, the wrapper INI file includes a plurality of logical sections that are marked by titles in square brackets. By providing the wrapper application 310 with inputs via a wrapper INI file, configuring variables of the batched commands follow well defined conventions.

Each section corresponds to and provides a rules base for each command within the corresponding batched command file. For example, the md command of the batched command file corresponds to rules base section 410, the copy command of the batched command file corresponds to rules base section 412. The xcopy command of the batched command file corresponds to a rules base section 414 and the transform command of the batched command file corresponds to rules base section 416.

The md command rules base section 410 includes a plurality of rules. More specifically, the rules base 410 includes an OnError rule, an OnErrorRun rule, an ErrorOnLevel rule, and ErrorOnAction rule and an ErrorMessage rule.

The copy rules base section 412 includes a plurality of rules. More specifically, the rules base 412 includes an OnError rule, an OnErrorRun rule, an ErrorOnLevel rule, and ErrorOnAction rule and an ErrorMessage rule.

The xcopy rules base section 414 includes a plurality of rules. More specifically, the rules base 412 includes an OnError rule, an OnErrorRun rule, an ErrorOnLevel rule, and ErrorOnAction rule and an ErrorMessage rule.

The transform rules base section 416 includes a plurality of rules. More specifically, the rules base 416 includes an OnError rule, an OnErrorRun rule, an ErrorOnLevel rule, and ErrorOnAction rule and an ErrorMessage rule.

Not only does such a method simplify the batch command file writing process, the method provides the developer of batch command files with an integrated rule based exception handling and debug output. Additionally, the OnErrorRun functionality of the INI file allows for a developer to generate a more complex error handling routine if such a routine is desired.

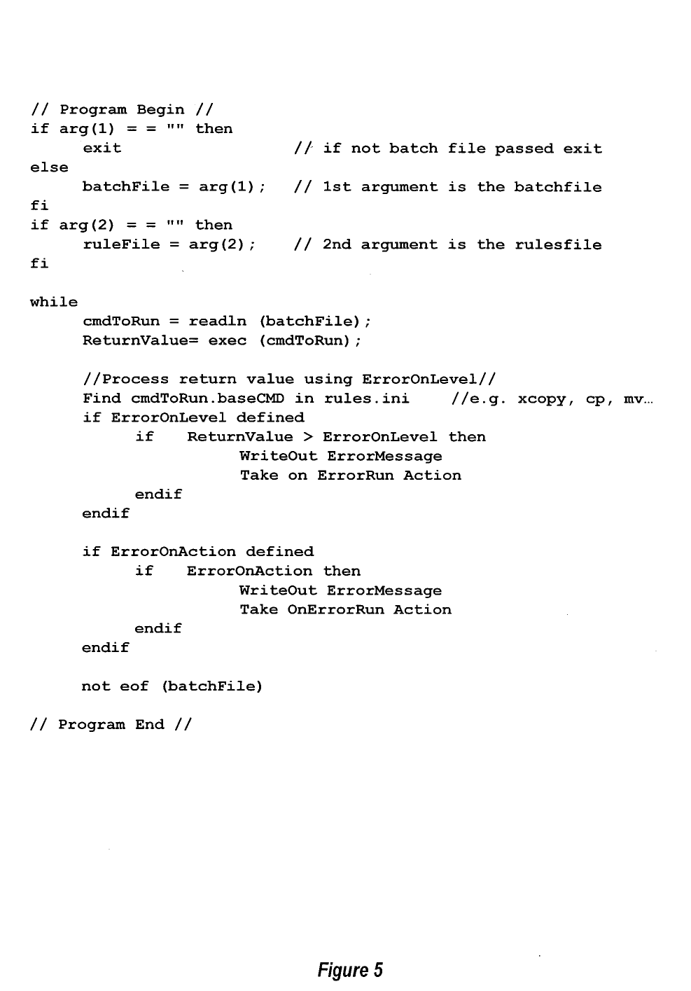

Referring to FIG. 5, the execution of the input batch file is initiated via the following command.

RUNBAT.EXE c:\batch.bat

The wrapper application processes the call as shown in FIG. 5.

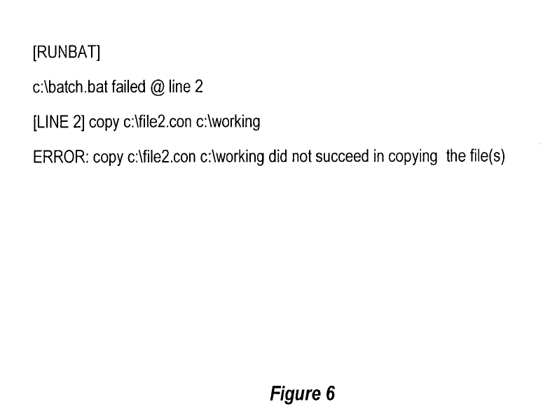

Referring to FIG. 6, an example of possible error event output that is generated by executing the batched command file method is shown. More specifically, the execution of the input batch file is by calling a run batch executable, e.g., “RUNBAT.EXE c:\batch.bat”. When the batched command file is executed by the wrapper application 310, the wrapper application 310 indicates the execution of the wrapper application, e.g., “[RUNBAT]”. The wrapper application then can indicate that an error has occurred and which line within the batched command file caused the error. The wrapper application may provide further information on what caused the error to occur, e.g., “c:\working did not succeed in copying the file(s)”.

Accordingly, the method provides for specific processing and monitoring of commands within a batched command file. Also, the method provides a convenient and easily modifiable means to incorporate error handling capability when executing batched command files.

Other Embodiments

Other embodiments are within the following claims.

For example, while in the described embodiment, the input to the wrapper application is via an INI file. It will be appreciated that other types of files may be used to provide the input. For example, the input may be via a pointer to a registry file.

Also for example, the above-discussed embodiments include software modules that perform certain tasks. The software modules discussed may include script, batch, or other executable files. The software modules may be stored on a machine-readable or computer-readable storage medium such as a disk drive. Storage devices used for storing software modules may be magnetic floppy disks, hard disks, or optical discs such as CD-ROMs or CD-Rs, for example. A storage device used for storing firmware or hardware modules may also include a semiconductor-based memory, which may be permanently, removably or remotely coupled to a microprocessor memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a software module for calling sub-modules may be decomposed so that each sub-module performs its function and passes control directly to another sub-module.

Consequently, the invention is intended to be limited only by the spirit and scope of the appended claims, giving full cognizance to equivalents in all respects.

What is claimed is:

1. A method for managing a batched command file comprising:
providing a batched command file to a wrapper application;
providing an initialization file to the wrapper application, the initialization file including rules base for commands within the batched command file; and
executing the batched command file with the wrapper application using the rules base provided by the initialization file.

2. The method of claim 1 wherein:
the initialization file is an INI file.

3. The method of claim 1 wherein:
the rules base provide rules on error handling when executing the batched command file.

4. The method of claim 3 wherein:
the rules on error handling enable calling an error handling routine upon encountering an error when executing the batched command file.

5. The method of claim 1 wherein:
the wrapper application provides a formatted output of the execution of the batched command file.

6. A system for managing a batched command file comprising:
a wrapper application,
a batched command file, the batched command file being provided to the wrapper application;
an initialization file, the initialization file being provided to the wrapper application, the initialization file including rules base for commands within the batched command file, the wrapper application executing the batched command file using the rules base provided by the initialization file.

7. The system of claim 6 wherein:
the initialization file is an INI file.

8. The system of claim 6 wherein:
the rules base provide rules on error handling when executing the batched command file.

9. The system of claim 8 wherein:
the rules on error handling enable calling an error handling routine upon encountering an error when executing the batched command file.

10. The system of claim 6 wherein:
the wrapper application provides a formatted output of the execution of the batched command file.

11. An information handling system, the information handling system executing a batched command file comprising:
a processor;
a memory coupled to the processor,
a wrapper application stored on the memory,
a batched command file stored on the memory, the batched command file being provided to the wrapper application when the wrapper application executes;
an initialization file stored on the memory, the initialization file being provided to the wrapper application when the wrapper application executes, the initialization file including rules base for commands within the batched command file, the wrapper application executing the batched command file using the rules base provided by, the initialization file.

12. The information handling system of claim 11 wherein:
the initialization file is an INI file.

13. The information handling system of claim 111 wherein:
the rules base provide rules on error handling when executing the batched command file.

14. The information handling system of claim 13 wherein:
the rules on error handling enable calling an error handling routine upon encountering an error when executing the batched command file.

15. The information handling system of claim 11 wherein:
the wrapper application provides a formatted output of the execution of the batched command file.

16. An apparatus for managing a batched command file comprising:
a wrapper application;
means for providing a batched command file to the wrapper application;
means for providing an initialization file to the wrapper application, the initialization file including rules base for commands within the batched command file; and
means for executing the batched command file with the wrapper application using the rules base provided by the initialization file.

17. The apparatus of claim 16 wherein:
the initialization file is an INI file.

18. The apparatus of claim 16 wherein:
the rules base provide rules on error handling when executing the batched command file.

19. The apparatus of claim 18 wherein:
the rules on error handling enable calling an error handling routine upon encountering an error when executing the batched command file.

20. The apparatus of claim 16 wherein:
the wrapper application provides a formatted output of the execution of the batched command file.
